(19) United States
(12) Patent Application Publication
(10) Pub. No.: US 2024/0272326 A1
(43) Pub. Date: Aug. 15, 2024

(54) IDENTIFICATION AND QUANTIFICATION OF SUBSURFACE GEOBODIES

(71) Applicant: Saudi Arabian Oil Company, Dhahran (SA)

(72) Inventors: Saleh K. Almeshari, Al Khobar (SA); Aqeel M. Khalifa, Dammam (SA); Abdullah Al Hadab, Al Hofuf (SA)

(21) Appl. No.: 18/169,056

(22) Filed: Feb. 14, 2023

(51) Int. Cl. G01V 99/00; G01V 1/00; G01V 1/30; G01V 1/50

(52) U.S. Cl. CPC G01V 20/00; G01V 1/001; G01V 1/306; G01V 1/50

(57) ABSTRACT

Example computer-implemented methods, media, and systems for identifying and quantifying diagenetically produced cemented subsurface geobodies are disclosed. One example computer-implemented method includes obtaining one or more borehole logs of one or more wells in a subsurface reservoir. A functional relationship between acoustic impedance of the subsurface reservoir and volume of diagenetically produced cemented geobody in the subsurface reservoir is determined based on the one or more borehole logs. Multiple acoustic impedance cubes of the subsurface reservoir is obtained. Multiple volumes of diagenetically produced cemented geobodies in the subsurface reservoir is determined based on the functional relationship and the multiple acoustic impedance cubes of the subsurface reservoir, where the multiple volumes correspond to the multiple acoustic impedance cubes of the subsurface reservoir. Locations of the diagenetically produced cemented geobodies in the subsurface reservoir are mapped using the determined multiple volumes of the diagenetically produced cemented geobodies.

### TECHNICAL FIELD

The present disclosure relates to computer-implemented methods, media, and systems for identifying and quantifying subsurface geobodies.

### BACKGROUND

Elastic properties such as acoustic impedance (AI) of rocks in a subsurface reservoir can be used to guide porosity estimation in subsurface areas away from wells. Relatively high acoustic impedance values may represent diagenetically produced cemented geobodies instead of tight reservoir without diagenetically produced cemented geobodies, because the diagenetically produced cemented geobodies tend to increase the stiffness of the rock medium.

### SUMMARY

The present disclosure involves computer-implemented methods, media, and systems for identifying and quantifying diagenetically produced cemented subsurface geobodies. One example computer-implemented method includes obtaining one or more borehole logs of one or more wells in a subsurface reservoir. A functional relationship between acoustic impedance of the subsurface reservoir and volume of diagenetically produced cemented geobody in the subsurface reservoir is determined based on the one or more borehole logs. Multiple acoustic impedance cubes of the subsurface reservoir is obtained. Multiple volumes of diagenetically produced cemented geobodies in the subsurface reservoir is determined based on the functional relationship and the multiple acoustic impedance cubes of the subsurface reservoir, where the multiple volumes correspond to the multiple acoustic impedance cubes of the subsurface reservoir. Locations of the diagenetically produced cemented geobodies in the subsurface reservoir are mapped using the determined multiple volumes of the diagenetically produced cemented geobodies.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example workflow of quantifying diagenetically produced subsurface geo-bodies in a subsurface reservoir.

FIG. 2 illustrates an example of changes in elastic log signature around a diagenetically produced cemented zone in a reservoir.

FIG. 3 illustrates an example of elastic signature modeled using a range of volumes of diagenetically produced cement.

FIG. 4 illustrates an example of synthetic seismic response corresponding to the modeled elastic signature in FIG. 3.

FIG. 5 illustrates example of a cross-plot that relates acoustic impedance to volume of anhydrite cement in a subsurface reservoir.

FIG. 6 illustrates an example of a cross-plot that relates acoustic impedance to volume of anhydrite cement at seismic scale.

FIG. 7 illustrates an example of multiple acoustic impedance cubes generated from seismic inversion, as well as the corresponding anhydrite cubes transformed from the multiple acoustic impedance cubes using the functional relationship in FIG. 6.

FIG. 8 illustrates an example of a cross-section with lines corresponding to drilled wells in an area of interest.

FIG. 9 illustrates an example of a map showing wells with different relative anhydrite volumes in an extended region.

FIG. 10 illustrates an example process of quantifying diagenetically produced cemented subsurface geobodies.

FIG. 11 is a schematic illustration of example computer systems that can be used to execute implementations of the present disclosure.

Like reference numbers and designations in the various drawings indicate like elements.

### DETAILED DESCRIPTION

This disclosure relates to identification and quantification of diagenetically produced cemented subsurface geobodies. In some implementations, a functional relationship between acoustic impedance of a subsurface reservoir and volume of diagenetically produced cemented geobody in the subsurface reservoir can be generated using well log data from wells in the subsurface reservoir. The function relationship can then be used to transform elastic property cubes generated from seismic inversion into volumes of diagenetically produced cemented geobodies in the subsurface reservoir. By incorporating the volumes of diagenetically produced cement geobodies and their locations, the locations with porous sand and some diagenetically produced subsurface geobodies rather than tight sand can be identified. The quantified volumes of diagenetically produced cemented geobodies can also be incorporated into porosity and permeability modeling to aid three-dimensional reservoir modeling.

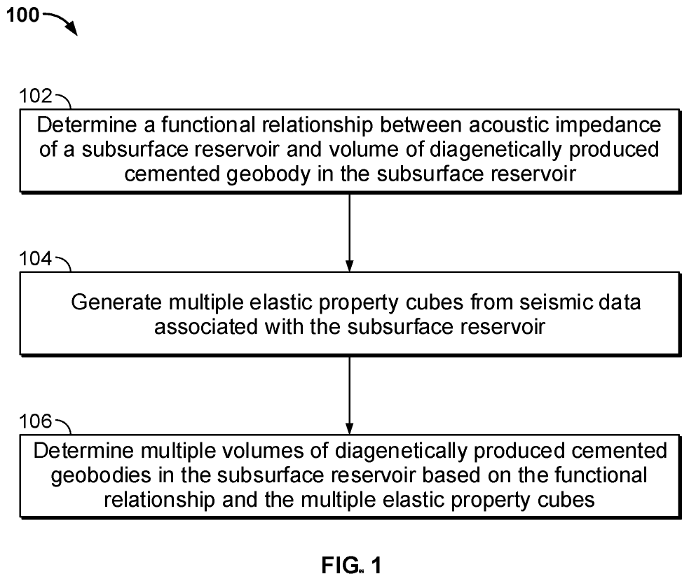

FIG. 1 illustrates an example workflow 100 of quantifying diagenetically produced subsurface geo-bodies in a subsurface reservoir. At 102, a functional relationship between acoustic impedance of a reservoir and volume of diagenetically produced cemented geobody in the subsurface reservoir is determined. In some implementations, the functional relationship can be determined using well log data from wells in the subsurface reservoir, as described below.

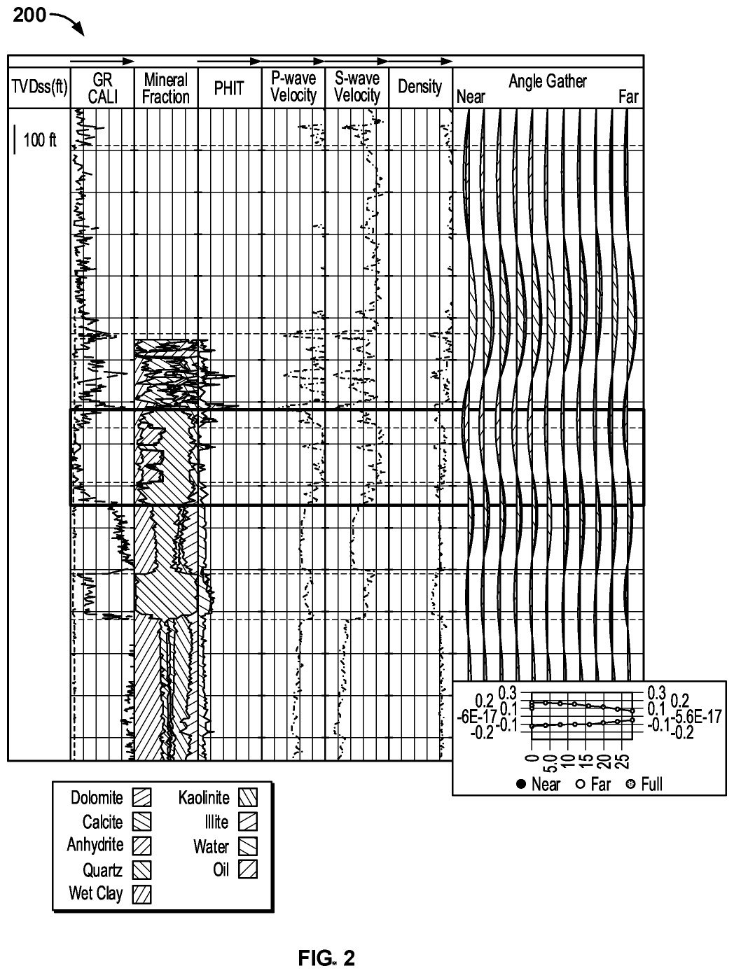

FIG. 2 illustrates an example 200 of changes in elastic log signature around a diagenetically produced cemented zone in a reservoir. For example 200, the diagenetically produced cemented zone includes anhydrite (ANH) cemented geobodies. FIG. 2 includes gamma ray (GR) log measurement in API (American Petroleum Institute) units, caliber (CALI) log measurement that provides a continuous measurement of the size and shape of a borehole along its depth, total porosity (PHIT) log measurement, measured p-wave velocity from sonic tools in meters per second, measured s-wave velocity from sonic tools in meters per second, measured bulk density of the rock in grams per centimeters cube, and angle gather measurement, which represents seismic pre-stack gathers generated. The near end of the angle gather measurement shows the reflections coming from seismic waves traveling down the subsurface with small incident angles. The far end of the angle gather measurement shows the reflections coming from seismic waves with large incident angles. The near and far ends of the angle gather measurement can also translate respectively into a small separation between a hypothetical source and a receiver and a large separation between the pair of source and receiver. The plot at the bottom of FIG. 2 shows the values of seismic amplitude measured for each incident angle at the horizontal near and far lines which are placed on the top and base of the reservoir.

In some implementations, the volume of cement that is diagenetically produced, for example, by subsurface burial or thermal fluid processes, can be computed quantitatively by acquiring wireline borehole logs that capture geochemical variations, for example, weight fraction of calcium (Ca) and Sulfur (S). Similarly, it can be computed from geochemical analysis performed on rock chips or core samples from the borehole. The computed cement volume can then be compared to the measured porosity volume values, for example, using sonic, neutron, or density porosity logs, to determine the effect of diagenetically produced cement on the rock pore volume.

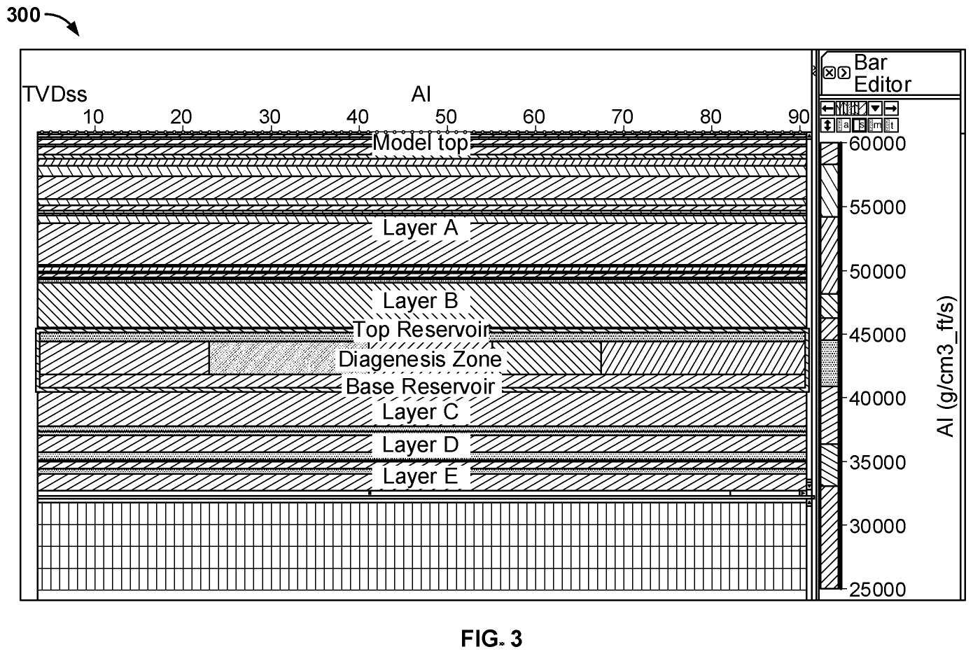

FIG. 3 illustrates an example 300 of elastic signature modeled using a range of volumes of diagenetically produced cement. For FIG. 3, the diagenetically produced cement is anhydrite cement, and the elastic signature is acoustic impedance. Acoustic impedance is one of the elastic properties of rocks that is related to the incompressibility and the rigidity of a certain material, and it governs how waves reflect and transmit between different layers of rocks. It can be calculated by multiplying the compressional wave velocity of a certain material with its bulk density. The horizontal axis in FIG. 3 represents seismic trace number which was synthetically generated corresponding to 90 traces which translates 90 hypothetical receivers distributed along a line. The changing intensity in FIG. 3 represents acoustic impedance values.

In some implementations, to generate the modeled elastic signature, the volume of anhydrite is used to replace the porosity volume in the rock for a range of porosity values, for example, from 0 to 35% of the rock volume, where 35% represents the maximum percentage of anhydrite in the sandstone rocks in the subsurface in a specific study area, and the porosity value can decrease with increasing depth of burial. Elastic signature can be computed for a range larger than 0 to 35% of the rock volume if field data shows such scenario. Synthetic acoustic impedance values can be computed based on known velocity and density of quartz and anhydrite minerals. Several iterations of this calculation can be made using different volumes of anhydrite cement within a range, for example, between 0 to 35% of the rock volume. The modeled acoustic impedance in the diagenesis zone of FIG. 3 represents scenarios going from the far left scenario of porous sand (porous without ANH) reservoir to the far right scenario of completely cemented geobody with anhydrite that comprises 35% of the rock volume.

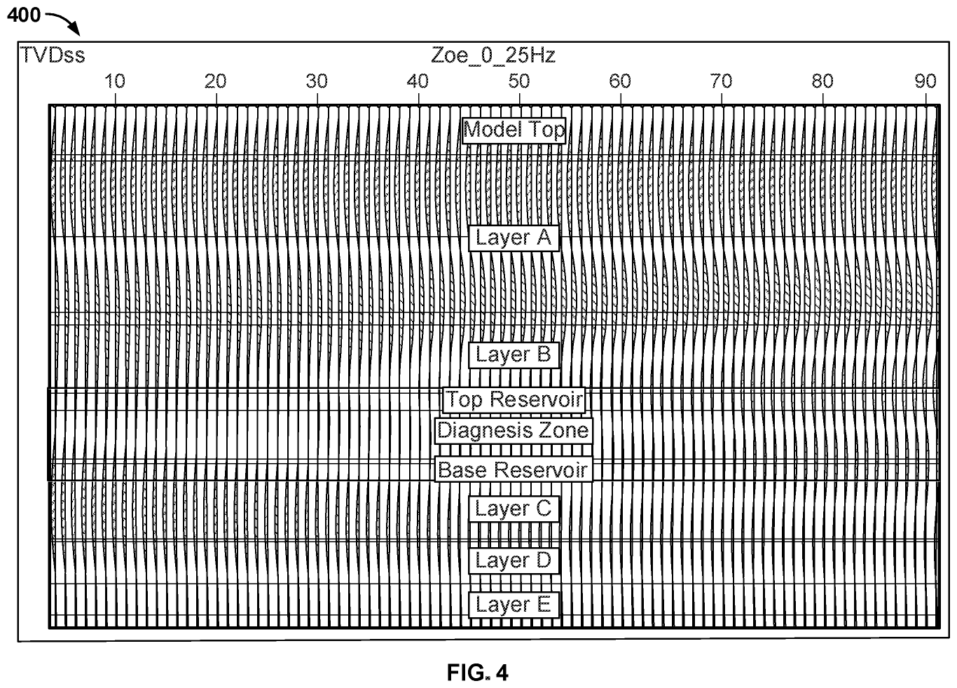

FIG. 4 illustrates an example 400 of synthetic seismic response corresponding to the modeled elastic signature in FIG. 3. As shown in FIG. 4, the synthetic seismic response in the diagenesis zone of FIG. 4 changes from a trough in the far left of FIG. 4 that corresponds to no anhydrite cement to a peak in the far right of FIG. 4 that corresponds to pore space that is completely cemented by anhydrite. This change indicates that there can be a contrast in seismic data when the diagenetic cementation is present in a subsurface reservoir. Similar to FIG. 3, the horizontal axis in FIG. 4 represents seismic trace number which was synthetically generated corresponding to 90 traces which translates 90 hypothetical receivers distributed along a line.

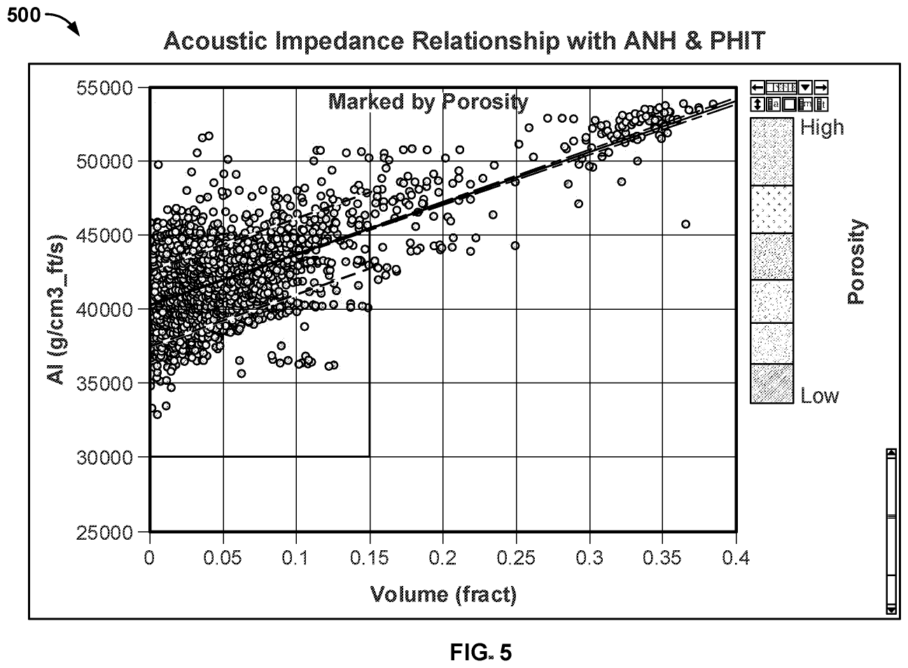

FIG. 5 illustrates an example 500 of a cross-plot that relates acoustic impedance to volume of anhydrite cement in a subsurface reservoir. In some implementations, the cross-plot can be generated using well log data from available wells in the gross reservoir zone. The data points in FIG. 5 are coded by total porosity to show the effect of cement volume increase on the porosity. The acoustic impedance values associated with data points in FIG. 5 can be computed at multiple depth points in the available wells using the well log data and can be compared to the volume of anhydrite, also computed using well log data, at the corresponding depth to create the cross-plot. FIG. 5 shows that a functional relationship between acoustic impedance and volume of anhydrite cement can be determined through data fitting to transform acoustic impedance values to corresponding anhydrite volumes. For example, the straight line in FIG. 5 is determined through data fitting to be the functional relationship between acoustic impedance and volume of anhydrite cement. In some implementations, multiple functional relationships can be produced using the cross-plot to quantify porous and non-porous anhydrite zones in the region of low volume of anhydrite cement.

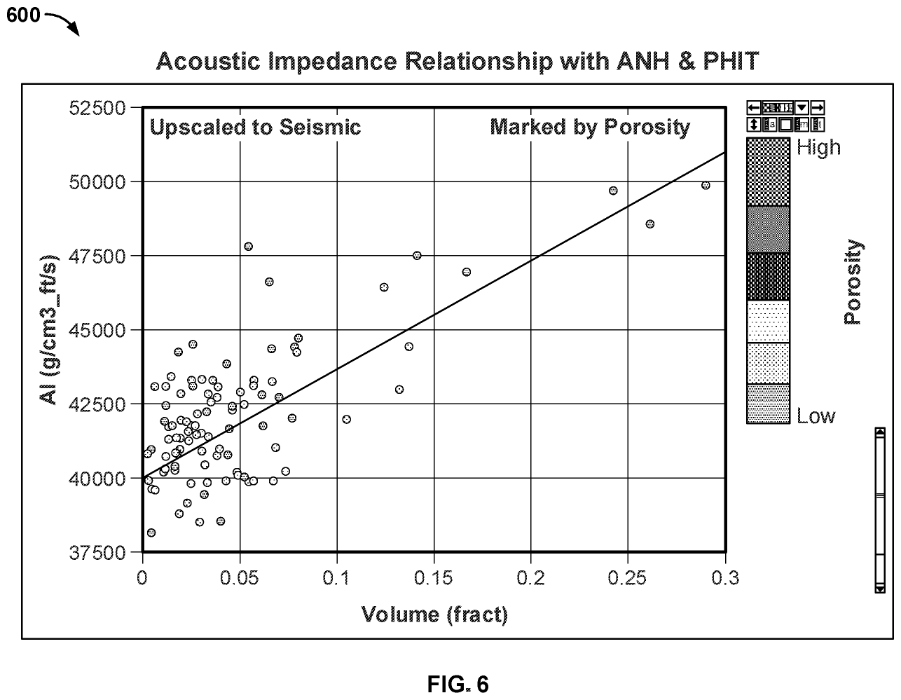

FIG. 6 illustrates an example 600 of a cross-plot that relates acoustic impedance to volume of anhydrite cement at seismic scale. In some implementations, the cross-plot in FIG. 6 can be generated by upscaling the cross-plot in FIG. 5, which is at log scale, to seismic scale. To generate the cross-plot in FIG. 6, well logs values used to generate the cross-plot in FIG. 5 can be filtered to match the frequency of the observed seismic data, and the filtered well logs can be cross plotted as shown in FIG. 6. As shown in FIG. 6, a functional relationship between volume of anhydrite cement and acoustic impedance generated through data fitting of data points in FIG. 6 is still present after the upscaling process. Therefore, acoustic impedance derived from seismic data can be used to estimate the volume of anhydrite cement.

At 104, multiple elastic property cubes are generated from seismic data associated with the subsurface reservoir. In some implementations, acoustic impedance cubes can be generated through seismic inversion, a process that can transform the seismic data from reflections only to actual rock properties such as elastic properties, including acoustic impedance. Seismic data can be generated by source of energy on the surface, and that energy travels through the subsurface and is reflected back to the surface when it encounters an interface between two materials with different elastic properties. Seismic inversion can be an inverse problem that converts the recorded seismic reflections to an elastic property model that is responsible for those reflections in order to approximate the earth model.

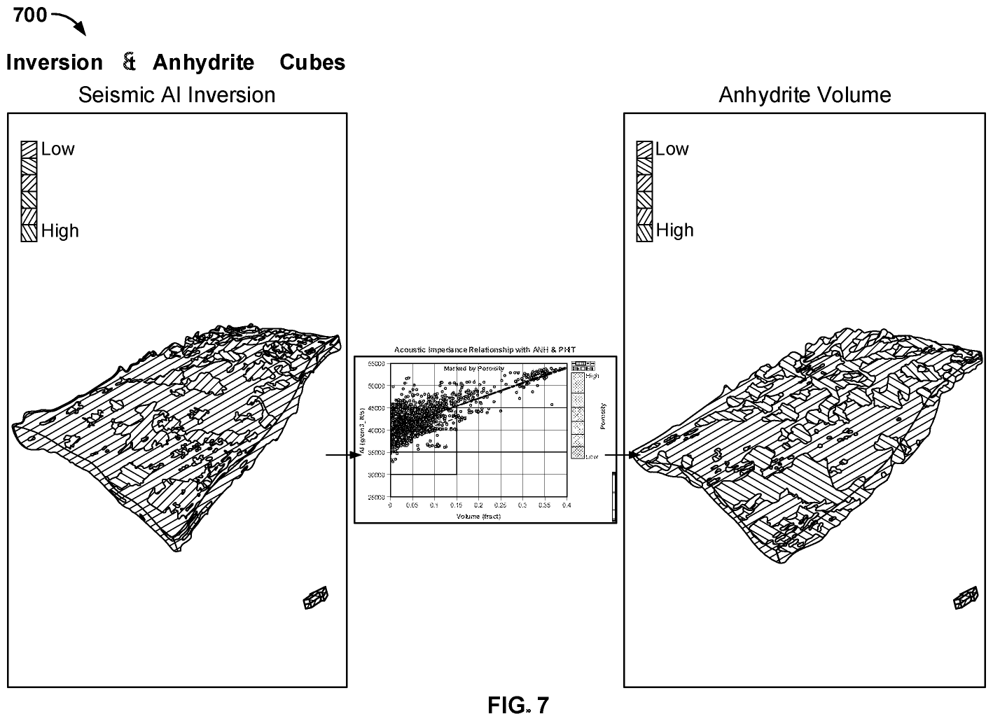

At 106, multiple volumes of diagenetically produced cemented geobodies in the reservoir are quantified based on the functional relationship and the multiple elastic property cubes. FIG. 7 illustrates an example 700 of multiple acoustic impedance cubes generated from seismic inversion in step 104, as well as the corresponding anhydrite cubes transformed from the multiple acoustic impedance cubes using the functional relationship determined in step 102. An example functional relationship is shown as the straight line in FIG. 6.

In some implementations, a cutoff value of the volume of anhydrite cement can be determined from the cross-plot in FIG. 5 and then used to locate the diagenetically produced cemented geobodies that have volumes that are equal to or larger than the cutoff value, based on the multiple volumes of diagenetically produced cemented geobodies determined in step 106. For example, as shown in FIG. 5, if the volume of an anhydrite cemented geobody is higher than a cutoff value of 15%, the anhydrite cemented geobody may reduce the reservoir capacity. In this example, the cutoff value of 15% is specific to the area or field associated with FIG. 5.

In some implementations, the quantified volume of anhydrite cement cube from step 106 can be used as an attribute to determine areas of highly cemented geo-bodies during subsurface geomodeling or to map the distribution of diagenetically produced cemented geobodies in a subsurface reservoir in three dimensions. These determined areas can be used to reduce exploration and production risks of a subsurface reservoir.

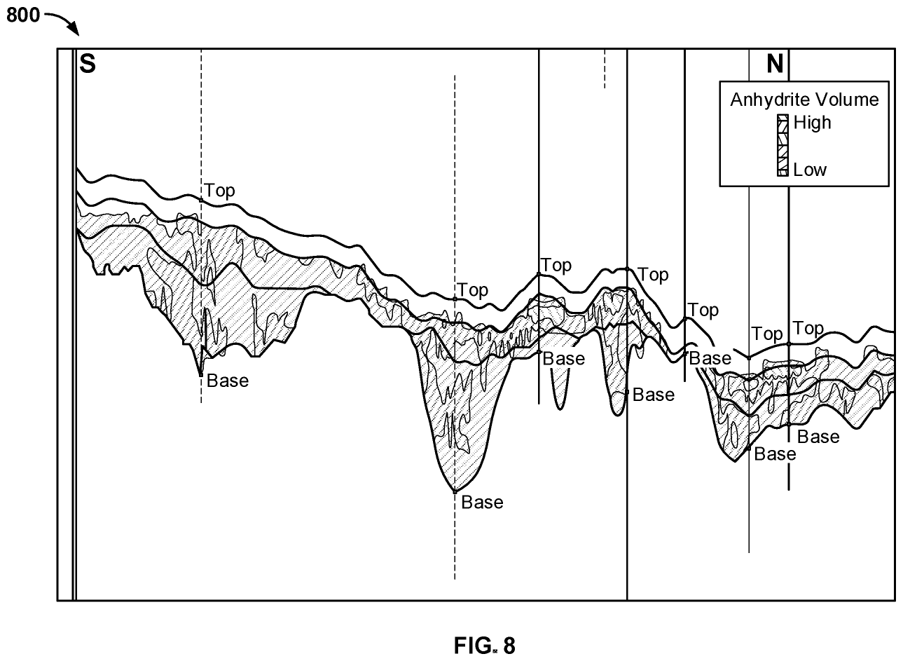

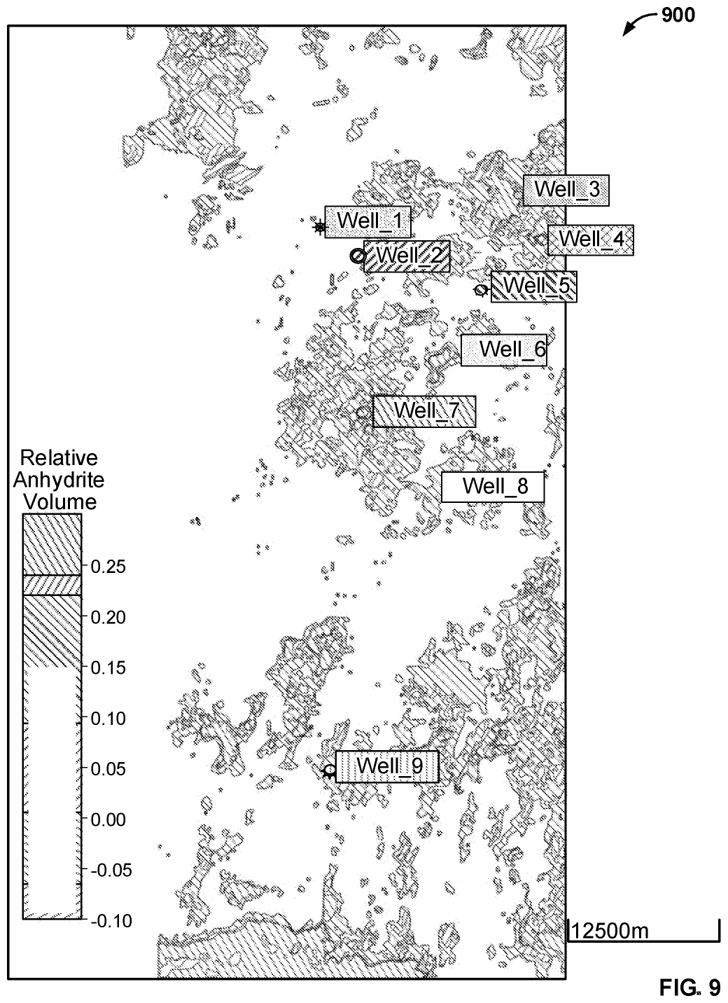

In some implementations, the process of quantifying volume of anhydrite cement cube using steps 102 to 106 can be validated using blind wells whose well log data are not used during the process of quantifying the volume of anhydrite cement cube. FIG. 8 illustrates an example 800 of a cross-section with lines corresponding to drilled wells in an area of interest. These cross section lines show wells that are not used to create the cross-plot in FIG. 5, in order to confirm the validity and accuracy of the process of quantifying volume of anhydrite cement cube. FIG. 8 also shows a two-dimensional representation of the distribution of the volume of anhydrite across the area of interest. The vertical scale of FIG. 8 represents depth in feet, and the horizontal scale of FIG. 8 is in meters. The intensity bar represents computed anhydrite volume. FIG. 9 illustrates an example 900 of a map showing wells with different relative anhydrite volumes in an extended region.

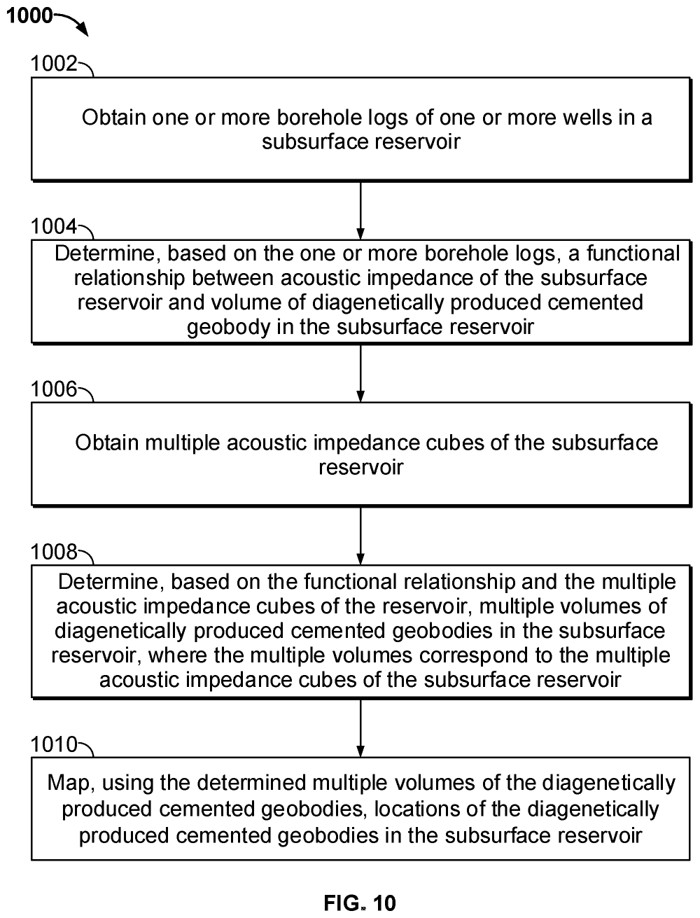

FIG. 10 illustrates an example process 1000 of quantifying diagenetically produced cemented subsurface geobodies. For convenience, process 1000 will be described as being performed by a system of one or more computers, located in one or more locations, and programmed appropriately in accordance with this specification.

At 1002, a computer system obtains one or more borehole logs of one or more wells in a subsurface reservoir.

At 1004, the computer system determines, based on the one or more borehole logs, a functional relationship between acoustic impedance of the subsurface reservoir and volume of diagenetically produced cemented geobody in the subsurface reservoir.

At 1006, the computer system obtains multiple acoustic impedance cubes of the subsurface reservoir.

At 1008, the computer system determines, based on the functional relationship and the multiple acoustic impedance cubes of the subsurface reservoir, multiple volumes of diagenetically produced cemented geobodies in the subsurface reservoir, where the multiple volumes correspond to the multiple acoustic impedance cubes of the subsurface reservoir.

At 1010, the computer system maps, using the determined multiple volumes of the diagenetically produced cemented geobodies, locations of the diagenetically produced cemented geobodies in the subsurface reservoir.

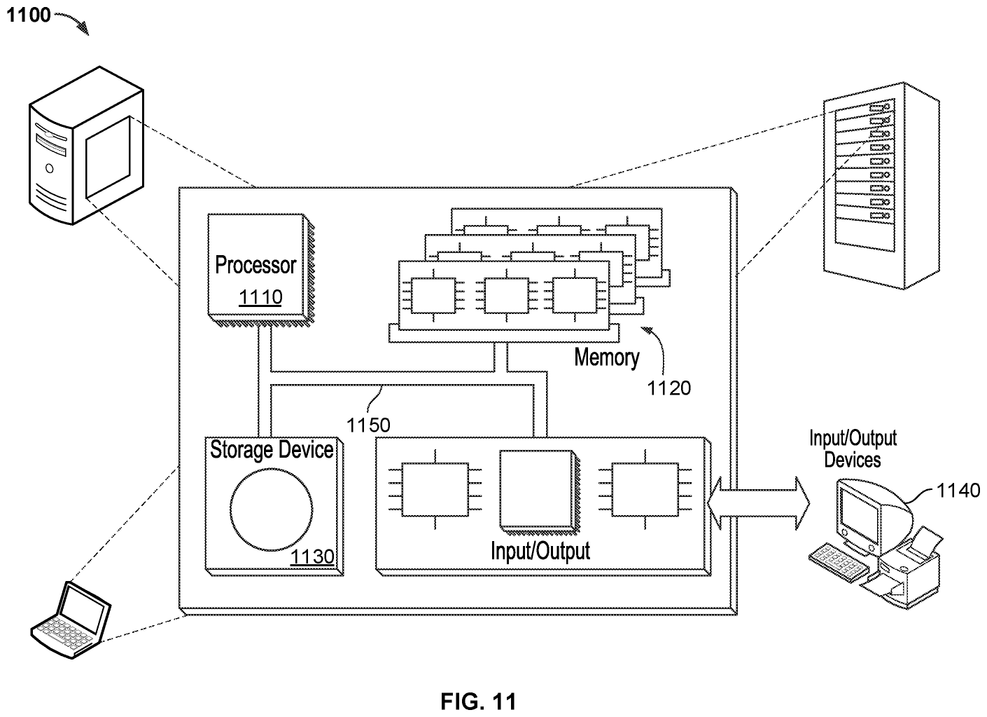

FIG. 11 illustrates a schematic diagram of an example computing system 1100. The system 1100 can be used for the operations described in association with the implementations described herein. For example, the system 1100 may be included in any or all of the server components discussed herein. The system 1100 includes a processor 1110, a memory 1120, a storage device 1130, and an input/output device 1140. The components 1110, 1120, 1130, and 1140 are interconnected using a system bus 1150. The processor 1110 is capable of processing instructions for execution within the system 1100. In some implementations, the processor 1110 is a single-threaded processor or a multi-threaded processor. The processor 1110 is capable of processing instructions stored in the memory 1120 or on the storage device 1130 to display graphical information for a user interface on the input/output device 1140.

The memory 1120 stores information within the system 1100. In some implementations, the memory 1120 is a computer-readable medium. The memory 1120 is a volatile memory unit. The memory 1120 is a non-volatile memory unit. The storage device 1130 is capable of providing mass storage for the system 1100. The storage device 1130 is a computer-readable medium. The storage device 1130 may be a floppy disk device, a hard disk device, an optical disk device, or a tape device. The input/output device 1140 provides input/output operations for the system 1100. The input/output device 1140 includes a keyboard and/or pointing device. The input/output device 1140 includes a display unit for displaying graphical user interfaces.

Certain aspects of the subject matter described here can be implemented as a method. One or more borehole logs of one or more wells in a subsurface reservoir are obtained. A functional relationship between acoustic impedance of the subsurface reservoir and volume of diagenetically produced cemented geobody in the subsurface reservoir is determined based on the one or more borehole logs. Multiple acoustic impedance cubes of the subsurface reservoir is obtained. Multiple volumes of diagenetically produced cemented geobodies in the subsurface reservoir is determined based on the functional relationship and the multiple acoustic impedance cubes of the subsurface reservoir, where the multiple volumes correspond to the multiple acoustic impedance cubes of the subsurface reservoir. Locations of the diagenetically produced cemented geobodies in the subsurface reservoir are mapped using the determined multiple volumes of the diagenetically produced cemented geobodies.

An aspect taken alone or combinable with any other aspect includes the following features. The diagenetically produced cemented geobodies in the subsurface reservoir include anhydrite cemented geobodies.

An aspect taken alone or combinable with any other aspect includes the following features. Determining the functional relationship includes determining, based on the one or more borehole logs, multiple acoustic impedance values at multiple depth points in the one or more wells; determining, based on the one or more borehole logs, a respective volume of a respective diagenetically produced cemented geobody associated with each of the multiple acoustic impedance values; generating a cross-plot of multiple data points that relate each of the multiple acoustic impedance values with the respective volume of the respective diagenetically produced cemented geobody; and determining the functional relationship by data fitting the multiple data points in the cross-plot.

An aspect taken alone or combinable with any other aspect includes the following features. The one or more borehole logs include one or more wireline borehole logs.

An aspect taken alone or combinable with any other aspect includes the following features. Obtaining the multiple acoustic impedance cubes of the subsurface reservoir includes generating, by applying a seismic inversion process to seismic data associated with the subsurface reservoir, the multiple acoustic impedance cubes of the subsurface reservoir.

An aspect taken alone or combinable with any other aspect includes the following features. Mapping the locations of the diagenetically produced cemented geobodies in the subsurface reservoir includes determining, based on the one or more borehole logs, a cutoff value for the multiple volumes of the diagenetically produced cemented geobodies; and mapping, based on the cutoff value and the multiple volumes of the diagenetically produced cemented geobodies, a respective location of each of the diagenetically produced cemented geobodies that has a corresponding volume that is equal to or larger than the cutoff value.

An aspect taken alone or combinable with any other aspect includes the following features. The functional relationship is a linear relationship.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method, comprising:
obtaining one or more borehole logs of one or more wells in a subsurface reservoir;
determining, based on the one or more borehole logs, a functional relationship between acoustic impedance of the subsurface reservoir and volume of diagenetically produced cemented geobody in the subsurface reservoir;
obtaining a plurality of acoustic impedance cubes of the subsurface reservoir;
determining, based on the functional relationship and the plurality of acoustic impedance cubes of the subsurface reservoir, a plurality of volumes of diagenetically produced cemented geobodies in the subsurface reservoir, wherein the plurality of volumes correspond to the plurality of acoustic impedance cubes of the subsurface reservoir; and
mapping, using the determined plurality of volumes of the diagenetically produced cemented geobodies, locations of the diagenetically produced cemented geobodies in the subsurface reservoir.

2. The computer-implemented method of claim 1, wherein the diagenetically produced cemented geobodies in the subsurface reservoir comprise anhydrite cemented geobodies.

3. The computer-implemented method of claim 2, wherein determining the functional relationship comprises:
determining, based on the one or more borehole logs, a plurality of acoustic impedance values at a plurality of depth points in the one or more wells;
determining, based on the one or more borehole logs, a respective volume of a respective diagenetically produced cemented geobody associated with each of the plurality of acoustic impedance values;
generating a cross-plot of a plurality of data points that relate each of the plurality of acoustic impedance values with the respective volume of the respective diagenetically produced cemented geobody; and
determining the functional relationship by data fitting the plurality of data points in the cross-plot.

4. The computer-implemented method of claim 1, wherein the one or more borehole logs comprise one or more wireline borehole logs.

5. The computer-implemented method of claim 1, wherein obtaining the plurality of acoustic impedance cubes of the subsurface reservoir comprises generating, by applying a seismic inversion process to seismic data associated with the subsurface reservoir, the plurality of acoustic impedance cubes of the subsurface reservoir.

6. The computer-implemented method of claim 1, wherein mapping the locations of the diagenetically produced cemented geobodies in the subsurface reservoir comprises:
determining, based on the one or more borehole logs, a cutoff value for the plurality of volumes of the diagenetically produced cemented geobodies; and
mapping, based on the cutoff value and the plurality of volumes of the diagenetically produced cemented geobodies, a respective location of each of the diagenetically produced cemented geobodies that has a corresponding volume that is equal to or larger than the cutoff value.

7. The computer-implemented method of claim 1, wherein the functional relationship is a linear relationship.

8. A non-transitory computer-readable medium storing one or more instructions executable by a computer system to perform operations comprising:
obtaining one or more borehole logs of one or more wells in a subsurface reservoir;
determining, based on the one or more borehole logs, a functional relationship between acoustic impedance of the subsurface reservoir and volume of diagenetically produced cemented geobody in the subsurface reservoir;
obtaining a plurality of acoustic impedance cubes of the subsurface reservoir;
determining, based on the functional relationship and the plurality of acoustic impedance cubes of the subsurface reservoir, a plurality of volumes of diagenetically produced cemented geobodies in the subsurface reservoir, wherein the plurality of volumes correspond to the plurality of acoustic impedance cubes of the subsurface reservoir; and
mapping, using the determined plurality of volumes of the diagenetically produced cemented geobodies, locations of the diagenetically produced cemented geobodies in the subsurface reservoir.

9. The non-transitory computer-readable medium of claim 8, wherein the diagenetically produced cemented geobodies in the subsurface reservoir comprise anhydrite cemented geobodies.

10. The non-transitory computer-readable medium of claim 9, wherein determining the functional relationship comprises:
determining, based on the one or more borehole logs, a plurality of acoustic impedance values at a plurality of depth points in the one or more wells;
determining, based on the one or more borehole logs, a respective volume of a respective diagenetically produced cemented geobody associated with each of the plurality of acoustic impedance values;
generating a cross-plot of a plurality of data points that relate each of the plurality of acoustic impedance values with the respective volume of the respective diagenetically produced cemented geobody; and
determining the functional relationship by data fitting the plurality of data points in the cross-plot.

11. The non-transitory computer-readable medium of claim 8, wherein the one or more borehole logs comprise one or more wireline borehole logs.

12. The non-transitory computer-readable medium of claim 8, wherein obtaining the plurality of acoustic impedance cubes of the subsurface reservoir comprises generating, by applying a seismic inversion process to seismic data associated with the subsurface reservoir, the plurality of acoustic impedance cubes of the subsurface reservoir.

13. The non-transitory computer-readable medium of claim 8, wherein mapping the locations of the diagenetically produced cemented geobodies in the subsurface reservoir comprises:
determining, based on the one or more borehole logs, a cutoff value for the plurality of volumes of the diagenetically produced cemented geobodies; and
mapping, based on the cutoff value and the plurality of volumes of the diagenetically produced cemented geobodies, a respective location of each of the diagenetically produced cemented geobodies that has a corresponding volume that is equal to or larger than the cutoff value.

14. The non-transitory computer-readable medium of claim 8, wherein the functional relationship is a linear relationship.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining one or more borehole logs of one or more wells in a subsurface reservoir;
determining, based on the one or more borehole logs, a functional relationship between acoustic impedance of the subsurface reservoir and volume of diagenetically produced cemented geobody in the subsurface reservoir;
obtaining a plurality of acoustic impedance cubes of the subsurface reservoir;
determining, based on the functional relationship and the plurality of acoustic impedance cubes of the subsurface reservoir, a plurality of volumes of diagenetically produced cemented geobodies in the subsurface reservoir, wherein the plurality of volumes correspond to the plurality of acoustic impedance cubes of the subsurface reservoir; and
mapping, using the determined plurality of volumes of the diagenetically produced cemented geobodies, locations of the diagenetically produced cemented geobodies in the subsurface reservoir.

16. The computer-implemented system of claim 15, wherein the diagenetically produced cemented geobodies in the subsurface reservoir comprise anhydrite cemented geobodies.

17. The computer-implemented system of claim 16, wherein determining the functional relationship comprises:
determining, based on the one or more borehole logs, a plurality of acoustic impedance values at a plurality of depth points in the one or more wells;
determining, based on the one or more borehole logs, a respective volume of a respective diagenetically produced cemented geobody associated with each of the plurality of acoustic impedance values;
generating a cross-plot of a plurality of data points that relate each of the plurality of acoustic impedance values with the respective volume of the respective diagenetically produced cemented geobody; and
determining the functional relationship by data fitting the plurality of data points in the cross-plot.

18. The computer-implemented system of claim 15, wherein the one or more borehole logs comprise one or more wireline borehole logs.

19. The computer-implemented system of claim 15, wherein obtaining the plurality of acoustic impedance cubes of the subsurface reservoir comprises generating, by applying a seismic inversion process to seismic data associated with the subsurface reservoir, the plurality of acoustic impedance cubes of the subsurface reservoir.

20. The computer-implemented system of claim 15, wherein mapping the locations of the diagenetically produced cemented geobodies in the subsurface reservoir comprises:
determining, based on the one or more borehole logs, a cutoff value for the plurality of volumes of the diagenetically produced cemented geobodies; and
mapping, based on the cutoff value and the plurality of volumes of the diagenetically produced cemented geobodies, a respective location of each of the diagenetically produced cemented geobodies that has a corresponding volume that is equal to or larger than the cutoff value.
